(19) United States
(12) Patent Application Publication
(10) Pub. No.: US 2007/0004450 A1
(43) Pub. Date: Jan. 4, 2007

(54) Mobile handheld electronic device with a removable cellphone

(76) Inventor: Jay G. Parikh, Redwood City, CA (US)

Correspondence Address: LAW OFFICE OF DAVID H. JUDSON, 15950 DALLAS PARKWAY, SUITE 225, DALLAS, TX, 75248, US

(21) Appl. No.: 11/172,081

(22) Filed: Jun. 30, 2005

(51) Int. Cl. H04M 1/00

(52) U.S. Cl. 455/556.1

(57) ABSTRACT

A mobile handheld electronic device having a given form factor includes a detachable cellular telephone carried within the mobile handheld electronic device, such that when the cellular telephone is positioned within the mobile handheld electronic device the form factor is unaltered. The mobile electronic device includes structure for establishing and maintaining a mechanical connection between the cellular telephone and the mobile handheld electronic device when the cellular telephone is carried within the mobile handheld electronic device, and structure for establishing an electrical connection between the cellular telephone and the mobile handheld electronic device when the cellular telephone is carried within the mobile handheld electronic device. Preferably, the cellular telephone has a battery distinct from a battery in the mobile handheld electronic device, and the cellular telephone battery is recharged when the cellular telephone is carried within the mobile handheld electronic device. When the cellular telephone is docked within the larger device, given data on the cellular telephone is synchronized with given data stored in the mobile handheld electronic device.

### BACKGROUND OF THE INVENTION

1. Technical Field

The present invention relates generally to handheld communicator devices having “all-in-one” functionality.

2. Background of the Related Art

In recent years, there has been much interest in handheld computing devices such as two-way pagers, Personal Digital Assistants (PDAs), portable email sending/receiving devices, and the new wave of data-ready cellular phones. With the desire to reduce the number of devices an individual must carry, many handheld computing device vendors are developing and launching new products that combine the power of many specialized individual devices into one “do it all” type devices. These combination devices are sometimes known as “communicator” devices and typically function as a mobile phone, digital personal organizer, email/web client, digital camera, pager and the like). Several Blackberry models (e.g. Model 7290) and the Palm Treo® line of products are representative communicator type devices. These devices also allow the mobile user to synchronize one such device with his/her main desktop/laptop computer. An advantage of using only a single device is that the mobile user is not required to synchronize several handheld devices with his or her personal computer and is not required to store the same information on multiple devices. For example, with a communicator device an address book does not need to be kept synchronized on both on a PDA and cellular phone. While these devices all aim to be the one device that does it all, they so by compromising form factor, i.e., the physical size, weight and shape of the device. The current communicator products are usually larger, bulkier, and not as portable as a normal PDA or cellular phone device.

In particular, these “all-in-one” communicator devices typically have large form factors and are not always convenient to carry for a mobile user. Also, because these devices are larger, they are more susceptible to being damaged or stolen. The large form factor can be a deterrent for any mobile user especially if all of the communicator functionality is not needed all the time. Imagine if a mobile user just wanted to go to the movies for the evening and did not want to carry the bulky communicator device. With today's products, many users prefer to carry both a PDA and cellular phone over a single communicator device.

Today, cellular phones and PDAs, by themselves, are benefiting from technology innovations that allow for them to reach very small form factors. Some examples of these very small and portable cell phones include the Motorola v60i and the Nokia 8260. The small form factors of these devices make them easy to transport or stow.

One interesting attempt to address form factor considerations is described in U.S. Pat. No. 6,850,780, issued to Gioscia et al. This patent describes a compact personal digital assistant (PDA) and cellular telephone supported in a single housing. The housing includes a foldable dual-sided display and can be manipulated into two distinct forms, a first (larger) form for the PDA, and a second (more compact) form for the cellular telephone. While this patent provides the benefit of two distinct devices in one device without compromising the respective form factor of either device, the device requires special structures (e.g., a foldable dual-side display) and requires the user to manipulate the housing into the separate form factors.

While the above-described patent provides an interesting design approach, there remains a need in the art to provide an improved communicator device. The present invention addresses this need.

### BRIEF SUMMARY OF THE INVENTION

It is a primary object of the present invention to provide a mobile handheld digital device (e.g., a personal digital assistant) that includes a removable, portable cellular telephone without modifying or altering the device's basic form factor.

It is another object of the invention to enhance a mobile handheld electronic device having a form factor by providing, within the handheld electronic device itself, a detachable cellular telephone. The detachable cellular telephone is carried within the mobile handheld electronic device such that when the cellular telephone is positioned within the handheld electronic device its form factor is or remains unaltered or substantially unaltered.

Another more specific object of the present invention is to provide a novel communicator device that allows a mobile user to undock and operate an integral cellular phone separately from the portion of the communicator device that provides the remaining functions (e.g., PDA, MP3 player, wireless email, camera, pager, or the like). In this way, the cellular phone can be transported independently of the PDA functions, allowing the mobile user to have more freedom when the extra weight/size of the whole communicator device is not needed. When the cellular phone is docked into the communicator device, however, the device functions as if it were one and still allows for the mobile user to have only one device in which to store all of his/her information.

It is still another object of the present invention to provide an enhanced “all-in-one” communicator device.

According to an embodiment of the present invention, a mobile handheld electronic device having a given form factor includes a detachable cellular telephone carried within the mobile handheld electronic device, such that when the cellular telephone is positioned within the mobile handheld electronic device the form factor is unaltered. The mobile electronic device also includes (a) first structure for establishing and maintaining a mechanical connection between the cellular telephone and the mobile handheld electronic device when the cellular telephone is carried within the mobile handheld electronic device, and (b) second structure for establishing an electrical connection between the cellular telephone and the mobile handheld electronic device when the cellular telephone is carried within the mobile handheld electronic device. Preferably, the cellular telephone has a battery distinct from a battery in the mobile handheld electronic device, and the cellular telephone battery is recharged when the cellular telephone is carried within the mobile handheld electronic device. When the cellular telephone is docked within the larger device, given data on the cellular telephone is synchronized with given data stored in the mobile handheld electronic device.

The inventive concept of supporting a small, removable cellular telephone within the form factor of an existing handheld electronic device is also extendable to other devices that can be “paired” with a cellular phone. For example, according to the invention, a portable, detachable cellular phone is docked with a portable music player (MP3 player, CD player, etc.) to create a single device. When separated, the cellular phone may be used to download a subset of music to allow the user to play music from his or her phone. Other devices that could be paired with the cellular phone include a camera, a wireless email device, a portable game player (e.g., Sony PSP), and a PDA.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a known communicator device having a form factor;

FIG. 2 illustrates how communicator device of FIG. 1 is modified to house a detachable cellular telephone according to the present invention;

FIG. 3 illustrates another embodiment of the present invention; and

FIG. 4 illustrates still another embodiment of the present invention.

### DETAILED DESCRIPTION OF AN ILLUSTRATIVE EMBODIMENT

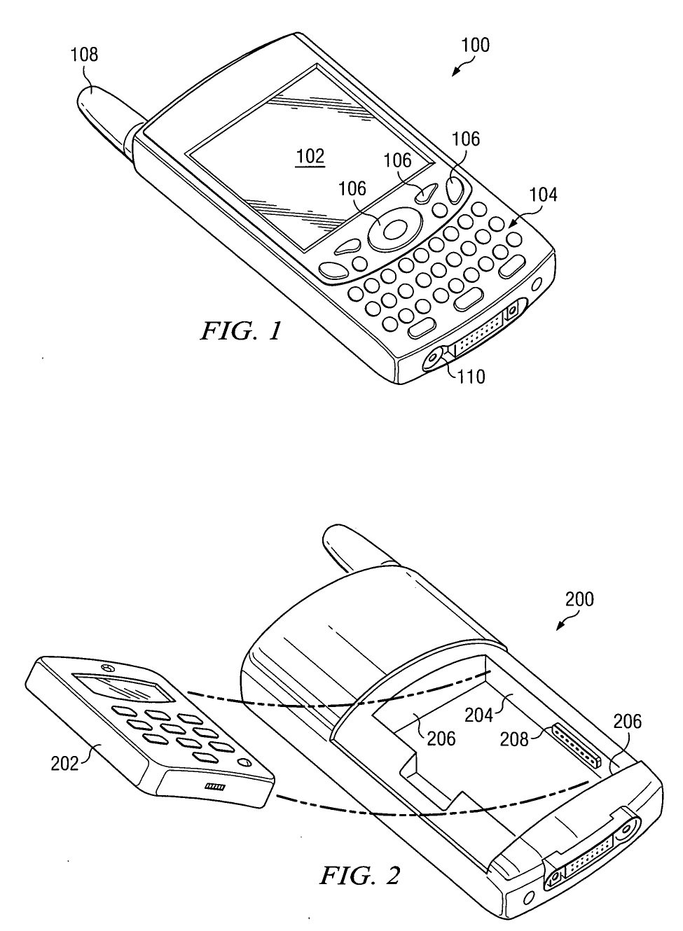

The present invention is implemented in a mobile handheld electronic device having a form factor. One such handheld electronic device is a “communicator,” which is a known device that has “all-in-one” functionality. Typically, this means that the single device functions as both a personal digital assistant (PDA) and cellular telephone, among other functions such as a digital camera, wirelesss e-mail client, and the like. Representative “communicator” devices are available commercially. One such device is the Palm Treo 650, which is illustrated in FIG. 1. The mobile handheld electronic device 100 comprises a housing having a known form factor, i.e., size and shape, with various man-machine interface components, e.g., a display 102, keypad 104, control buttons 106, and the like. An antenna 108 provides wireless connectivity to a telecommunications network (e.g., a GSM network, a CDMA network, or the like) and, optionally, to a wireless local area network (WLAN) or other Internet Protocol (IP) based network. The device comprises hardware and suitable storage (hard disk and volatile memory) for hosting the device's operating system and application programs (e.g., a Web browser, an e-mail client, a contacts handler, a photo manager, an SMS client, a calendar, a voice recognizer, and the like). The communicator device includes a built-in cellular telephone whose functions are accessed through the keypad (or via a “soft” keypad rendered on the display), an embedded microphone or similar audio device, and a speaker or similar audio device. The device may also include a built-in digital camera and include (within a compartment) a removable pointing device such as a stylus. An electrical connector 110 provides an electrical interface to a conductor (not shown) by which data may be provided to or from the device. All such characteristics and operations are well known in the art.

According to the present invention, a mobile handheld electronic device such as the “all-in-one” communicator shown in FIG. 1 is enhanced by inclusion of a removable cellular telephone, but wherein the form factor of the original device is maintained intact. This concept is illustrated in FIG. 2. Here, the communicator device 200 (like the device in FIG. 1) includes a detachable cellular telephone 202 that “fits” within the device but can be removed for separate handling. In a first, docked position, the cellular telephone is mechanically and electrically connected within the device itself. This is sometimes referred to a “connected” mode. In a second, undocked position, the cellular telephone is mechanically separated to present the mobile user with two (2) devices. This is sometimes referred to as a “disconnected” mode. In the docked position for connected mode, the mobile device presents a given form factor, and that form factor remains substantially unaltered when the cellular telephone is undocked and held in the disconnected mode as illustrated in FIG. 2. The removable cellular telephone may be the only telephone in the communicator, or the communicator may also include the conventional “built-in” telephone of the prior art. A wireless connection can be established from the removable telephone to the remainder of the electronic device, or from the removable telephone to one or more networks. The removable telephone 202 thus preferably is a standalone device that operates with or without power, hardware, software or other support from the electronic device from which it is removed. Nevertheless, the basic form factor (length, width and depth) of the mobile electronic device is unaltered by the telephone removal.

The detachable cellular telephone 200 is very compact and lightweight. Given the very small and compact size of the detachable cellular, typically this telephone will not include all of the functional characteristics of a conventional cellular telephone. The cellular phone may not even include a display, or a keypad (if suitable voice recognition software) is included. In one embodiment, the detachable cellular phone includes only the necessary wireless interfaces and software necessary to enable the phone to handle voice calls. Preferably, the cellular telephone operates in a low power drain mode (a “sleep mode”) when not in use to preserve the device's battery life. The detachable cellular phone could also make use of a Bluetooth transceiver. The Bluetooth transceiver would be used to communicate wirelessly with a Bluetooth headset, such as the Motorola HS810 Wireless Bluetooth Headset. Therefore, the detachable cellular phone could be built without the ear speaker and microphone further reducing the form factor of the device.

As can be seen in FIG. 2, the detachable cellular telephone is carried within the mobile handheld electronic device 200 such that when the cellular telephone is positioned within the mobile handheld electronic device the form factor is unaltered. The housing of the electronic device 200 includes suitable structure for establishing and maintaining a mechanical connection between the cellular telephone 202 and the mobile handheld electronic device 200 when the cellular telephone is carried within the mobile handheld electronic device. In this embodiment, the structure comprises the rear wall 204 and a set of sidewalls 206 that together comprise a cutout portion in which the device is positioned. The electronic device also includes circuitry (e.g., a electrical connector) 208 for establishing an electrical connection between the cellular telephone 200 and the mobile handheld electronic device 200 when the cellular telephone is carried within the mobile handheld electronic device. This electrical connection, in the alternative, may be effected using wireless technology (e.g., a Bluetooth connection).

Thus, according to the present invention, a detachable cellular phone is carried within a mobile device such as a PDA (or other portable/handheld device) that has been modified to support such cellular phone within the device's existing form factor. The portable device includes appropriate structure interfaces, both mechanical and software, to enable these two separate devices to function as one device, when docked, (communicator device) as well as two specialized devices (PDA and cellular phone) when undocked. As has been described, it is desirable that the device maintain its form factor both in docked (connected) and undocked (disconnected) form. Although one embodiment has been illustrated, any mechanical interface that allows the cellular phone component to connect with the existing PDA component form factor is within the scope of the present invention. For this reason, the cellular phone component will be smaller in physical dimensions than the PDA component. Thus, the PDA component must have a form factor that allows for it to accept the cellular component.

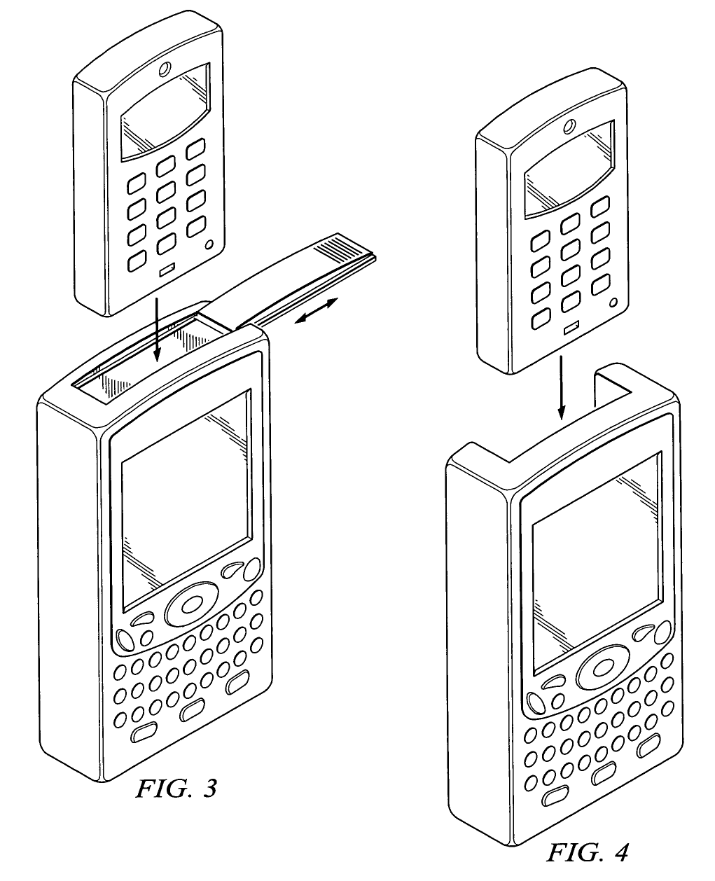

There are several approaches that this device may incorporate to allow for this docking capability. Theses approaches are divided into two basic categories: internal and external. An internal interface design comprises a “hatch” to an internal bay that when opened, allows for the cellular phone component to be inserted into the bay. When the hatch is secured, the cellular phone would be held internally to the structure of the PDA component, as illustrated in FIG. 3. In this embodiment, some portions of the cellular phone component body are visible when inserted to the bay; however, the internal frame of the PDA component provides structural support for the cellular phone assembly. The hatch may use a slider type of mechanism or a flip open mechanism. In the alternative, an external interface design comprises a latching mechanism on the external surface area of the PDA component. This latching mechanism accepts a complimentary hooking mechanism that is incorporated into the external body of the cellular phone, as illustrated in FIG. 4. As demonstrated in this diagram, the PDA component has a cutout area that that is the inverse form factor of the cellular phone. The cutout area accepts the cellular phone when the two components are docked.

In either case, the docking mechanisms provide a secure and firm mechanical connection. The cellular phone component should not vibrate or come accidentally undocked. The form factor of the combined device is rigid and sturdy. The mechanism, however, allows for quick and effortless undock of the cellular phone.

The mechanical connection also incorporates an appropriate electrical connection, as has been previously described and illustrated. This connection facilitates power supply sharing, information exchange and functional cooperation when the devices are docked. When the two components are connected, the electrical connection is established securely. Preferably, the electrical contacts do not protrude from either device when the devices are disconnected to protect the metal contacts from damage.

For data to stay synchronized between the PDA and cellular phone, the device provides the ability to transfer various user or other data between the two devices. The data synchronization occurs via the electrical connection established when the devices are connected. The mobile user also has the ability to synchronize various types of user data, like address book, calendar, notes, etc. between the devices before disconnecting the two components from each other. The synchronization may be one-way or two-way. In one-way mode, the PDA pushes its data to the cellular phone. In this embodiment, data on the cellular phone gets overwritten with current data stored on the PDA (although this is not required). In particular, the PDA is the master data storage and the cellular phone functions only as a slave. In two-way mode, there is actual synchronization for each data element on the PDA and cellular phone. Thus, the most up-to-date data on either device is synchronized to the other device. Examples of this might include, but not limited to, a mobile user updates a contact's phone number on the cellular phone component when in disconnected mode. When the user docks the cellular phone with the PDA, the devices synchronize and the updated phone number on the cellular phone is sent to the PDA. The old data on the PDA is overwritten with the new update from the cellular phone. Whatever synchronization method is implemented, the device preferably affords the mobile user with the option of automatic synchronization or prompted synchronization. That is, the synchronization may occur automatically when the devices are reconnected, or the user could prompt the devices to do the synchronization, e.g., via the PDA software interface. This synchronization method also handles different types of data that is expected to be exchanged between the devices (MP3, contact info, calendar info, e-mail, and the like)

For both devices to function separately, both the PDA component and cellular component preferably have their own battery power supply. A high powered, compact, rechargeable battery or batteries in each device allow for each device to have a good battery life when each device is operated independently. Alternatively, when the devices are connected, the battery power from each device can be harnessed to give even greater battery life to the docked unit. Optionally, the PDA device recharges the cellular phone when in docked configuration. This allows for the mobile user to have more flexibility by being able to recharge the cellular phone from the PDA device. Moreover, both devices preferably include an interface, accessible via the PDA and the cellular phone, to recharge both batteries from a power outlet. The power source may be a wall AC outlet or a DC car lighter outlet. The charging interface on the PDA and cellular phone preferably should be identical, so that a single charging adapter can be used. The charging adapter can charge the combined device, but it can also be used to charge the PDA or cellular phone separately.

This device has many advantages over the prior art. The combined unit is relatively small, lightweight and ergonomic, and it has a portable and consistent form factor with good battery life. The cellular telephone is easily detachable and carried separately.

Having described my invention, what I now claim is as follows.

1. In a mobile handheld electronic device having a form factor, the improvement comprising:
a detachable cellular telephone carried within the mobile handheld electronic device, such that when the cellular telephone is positioned within the mobile handheld electronic device the form factor is unaltered;
structure for establishing and maintaining a mechanical connection between the cellular telephone and the mobile handheld electronic device when the cellular telephone is carried within the mobile handheld electronic device; and
circuitry for establishing an electrical connection between the cellular telephone and the mobile handheld electronic device when the cellular telephone is carried within the mobile handheld electronic device.

2. The mobile handheld electronic device as described in claim 1 wherein the cellular telephone is detached for use.

3. The mobile handheld electronic device as described in claim 1 wherein the cellular telephone has a battery distinct from a battery in the mobile handheld electronic device.

4. The mobile handheld electronic device as described in claim 3 wherein the cellular telephone battery is recharged when the cellular telephone is carried within the mobile handheld electronic device.

5. The mobile handheld electronic device as described in claim 1 wherein the circuitry synchronizes given data on the cellular telephone with given data stored in the mobile handheld electronic device.

6. The mobile handheld electronic device as described in claim 1 wherein the electronic device is a personal digital assistant (PDA).

7. The mobile handheld electronic device as described in claim 1 wherein the electronic device is a music player.

8. The mobile handheld electronic device as described in claim 1 wherein the electronic device is a portable game player.

9. The mobile handheld electronic device as described in claim 1 wherein the electronic device is a portable e-mail client device.

10. The mobile handheld electronic device as described in claim 1 wherein the electronic device is a portable digital camera.
